(19) United States
(12) Patent Application Publication
(10) Pub. No.: US 2015/0084336 A1
(43) Pub. Date: Mar. 26, 2015

(54) CORRUGATED PIPE COUPLING AND REPAIR APPARATUS

(71) Applicant: Alan Gregory BROWN, Roswell, GA (US)

(72) Inventor: Alan Gregory BROWN, Roswell, GA (US)

(21) Appl. No.: 14/493,425

(22) Filed: Sep. 23, 2014

Related U.S. Application Data
(60) Provisional application No. 61/881,721, filed on Sep. 24, 2013.

(51) Int. Cl. F16L 25/00; F16L 21/06

(52) U.S. Cl. CPC F16L 25/0036; F16L 21/06
USPC 285/419

(57) ABSTRACT

A corrugated coupling may be provided. The corrugated coupling may be for coupling two cylindrical corrugated sections. The corrugated coupling may be a tubular element comprising a first portion and a second portion pivotably connected along a first edge, wherein the first edge comprises an integrated hinge. Each portion may have opposing second edges that come together in a closed configuration, forming the tubular element. Each second edge may provide a portion of an integrated snap closure that is positionable in a locked position sandwiching the joining two cylindrical corrugated sections between the first portion and the second portion and an unlocked position.

### CROSS-REFERENCE TO RELATED APPLICATION

This application claims the benefit of priority of U.S. provisional application number 61881721, filed 24 Sep. 2013, the contents of which are herein incorporated by reference.

### BACKGROUND OF THE INVENTION

The present invention relates to corrugated drain pipes and, more particularly, to means of joining sections of corrugated drain pipes.

Couplings for corrugated drain pipe currently on the market provide a very loose fit when connecting sections together. The loose connection between and to sections of corrugated drain pipe allows roots to grow into and/or debris to enter the pipes, resulting in blockages.

As can be seen, there is a need for a means for providing a tight coupling when joining sections of corrugated drain pipes.

### SUMMARY OF THE INVENTION

In one aspect of the present invention, a corrugated tubular coupling for joining two cylindrical corrugated sections comprises: a first portion of the tubular coupling, wherein the first portion is defined along its length by a first edge and a first outer edge, a second portion of the tubular coupling, wherein the second portion is defined along its length by the first edge and a second outer edge, wherein the first and second portions are pivotably connected along the first edge; and a snap closure provided along the length of the outer edges, the snap closure positionable in a locked position sandwiching the joining two cylindrical corrugated sections between the first portion and the second portion and an unlocked position.

In another aspect of the present invention, a method of joining two cylindrical sections having a plurality of corrugated segments, comprises the steps of: providing a tubular coupling having a plurality of corrugated segments, wherein the tubular coupling comprises: a first portion of the tubular coupling, wherein the first portion is defined along its length by a first edge and a first outer edge, a second portion of the tubular coupling, wherein the second portion is defined along its length by the first edge and a second outer edge, wherein the first and second portions are pivotably connected along the first edge; a snap closure provided along the length of the outer edges, and the snap closure positionable in a locked position sandwiching the joining two cylindrical corrugated sections between the first portion and the second portion and an unlocked position; placing the two cylindrical corrugated sections end-to-end on the first or second portion so that the each cylindrical corrugated section has at least a predetermined number of corrugated segments mated with the complementary corrugated segments of the first or second portion; and positioning the snap closure in the locked position.

These and other features, aspects and advantages of the present invention will become better understood with reference to the following drawings, description and claims.

### BRIEF DESCRIPTION OF THE DRAWINGS

FIG. 1A is a perspective view of an exemplary embodiment of the present invention, illustrating use;

FIG. 1B is a perspective view of an exemplary embodiment of the present invention, illustrating use;

FIG. 2A is a perspective view of an exemplary embodiment of the present invention, illustrating use in an open configuration;

FIG. 2B is a perspective view of an exemplary embodiment of the present invention, illustrating use in an open configuration;

FIG. 3A is a perspective view of an exemplary embodiment of the present invention, illustrating use in a closed configuration;

FIG. 3B is a perspective view of an exemplary embodiment of the present invention, illustrating use in a closed configuration;

FIG. 4 is a section view of an exemplary embodiment of the present invention;

FIG. 4A is a detail section view of FIG. 4 of an exemplary embodiment of the present invention;

FIG. 5A is a section view and detail section views of an exemplary embodiment of the present invention, taken along line 5A-5A of FIG. 3A;

FIG. 5B is a section view and detail section views of an exemplary embodiment of the present invention, taken along line 5B-5B of FIG. 3B;

FIG. 6 is a top plan view of an exemplary embodiment of an integrated snap closure of the present invention;

FIG. 7 is a section view of an exemplary embodiment of an integrated snap closure of the present invention;

FIG. 7A is a detail section view of FIG. 7 of an exemplary embodiment of an integrated hinge of the present invention; and

FIG. 7B is a detail section view of FIG. 7 of an exemplary embodiment of an integrated hinge of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a corrugated coupling for coupling two cylindrical corrugated sections. The corrugated coupling may be a tubular element comprising a first portion and a second portion pivotably connected along a first edge, wherein the first edge comprises an integrated hinge. Each portion may have opposing second edges that come together in a closed configuration, forming the tubular element. Each second edge may provide a portion of an integrated snap closure that is positionable in a locked position sandwiching the joining two cylindrical corrugated sections between the first portion and the second portion and an unlocked position.

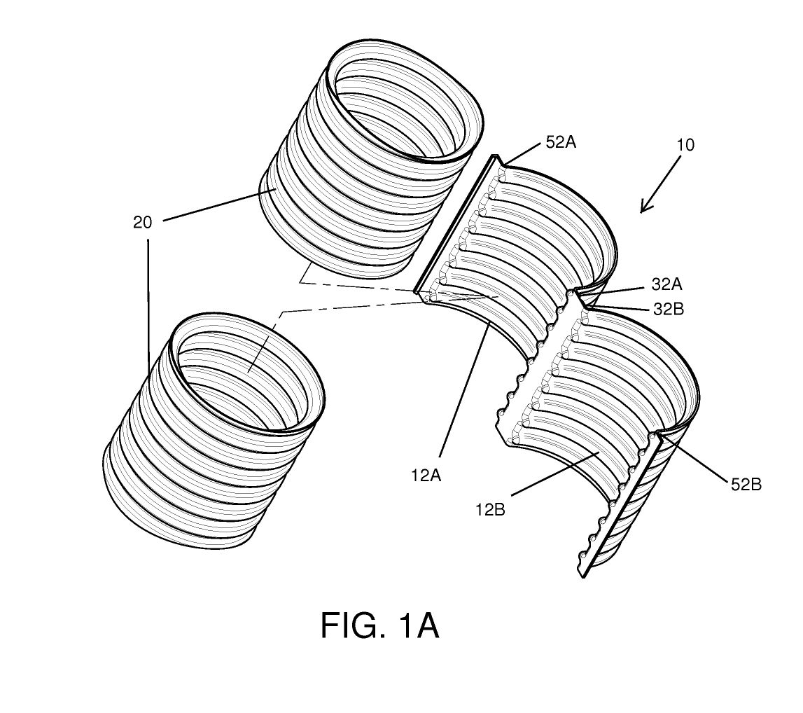

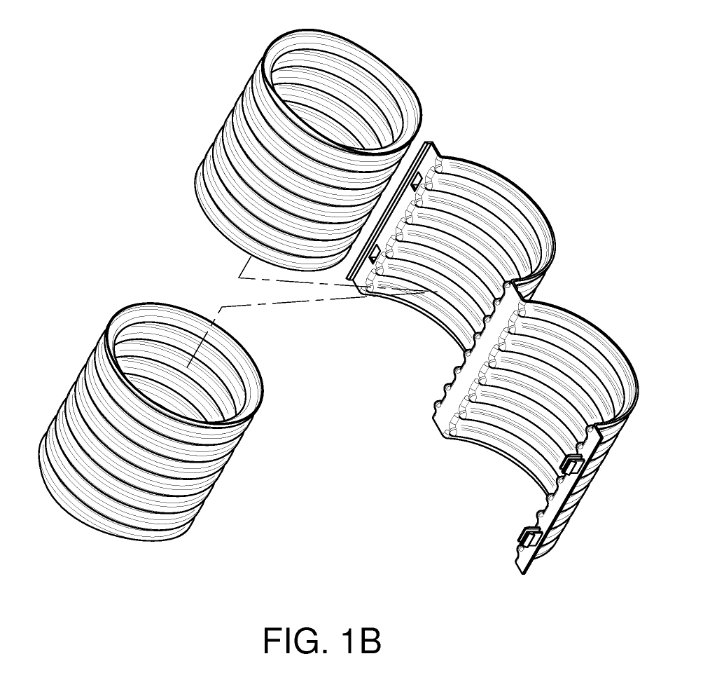

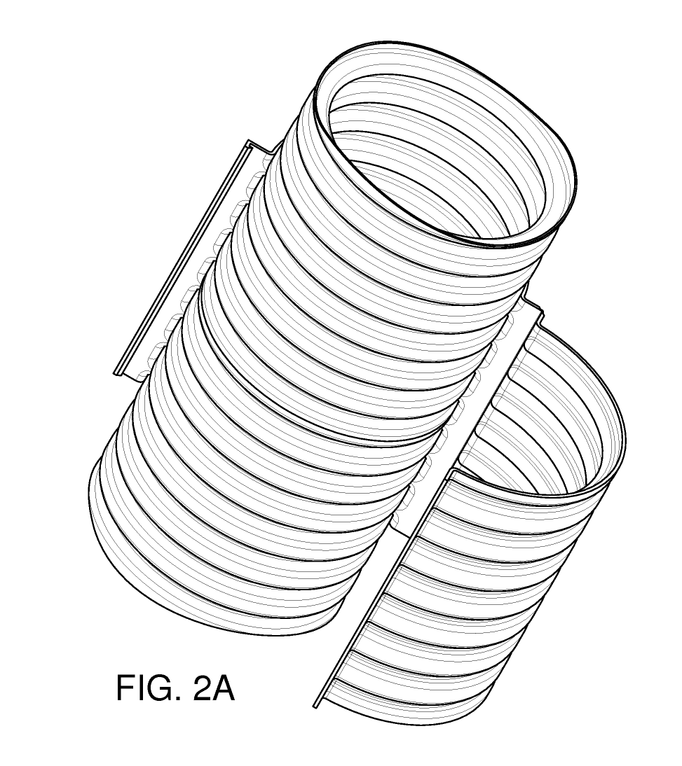

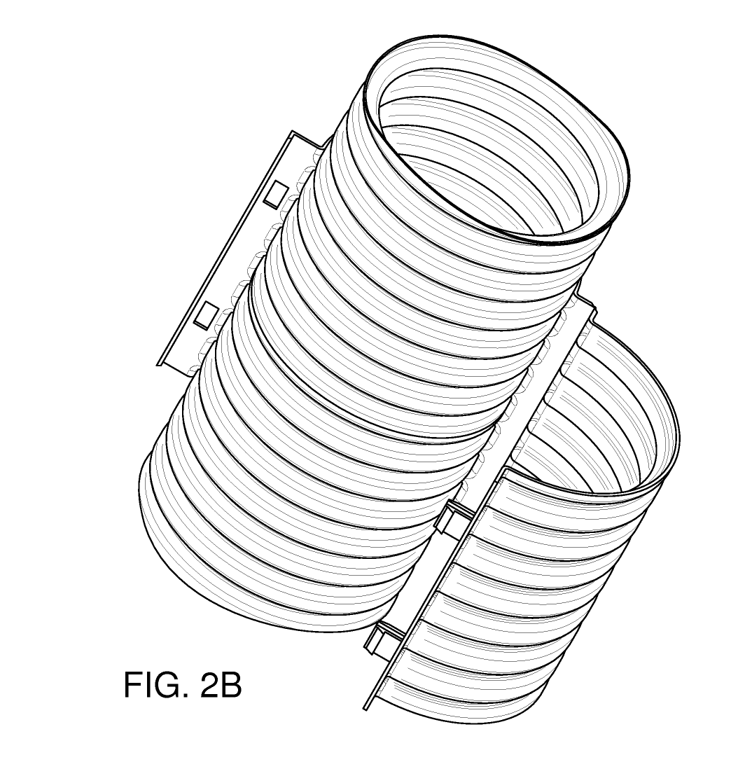

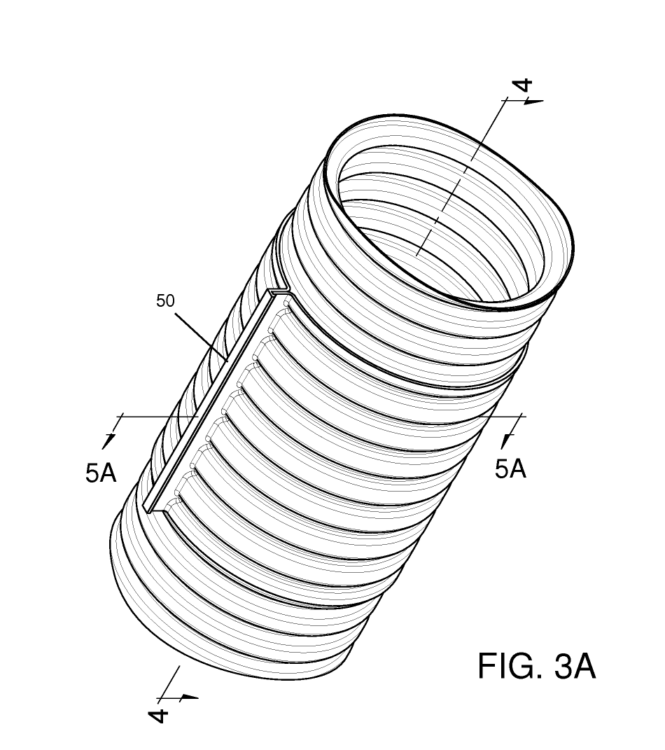

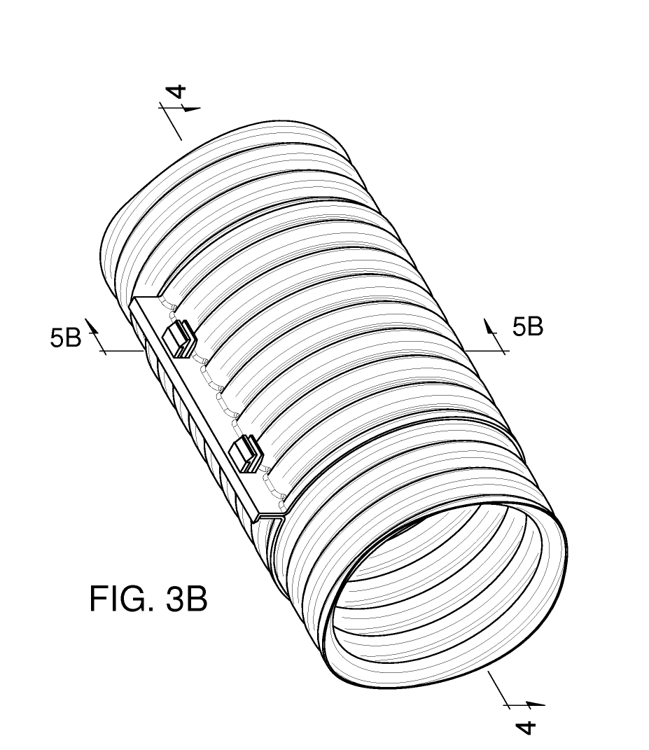

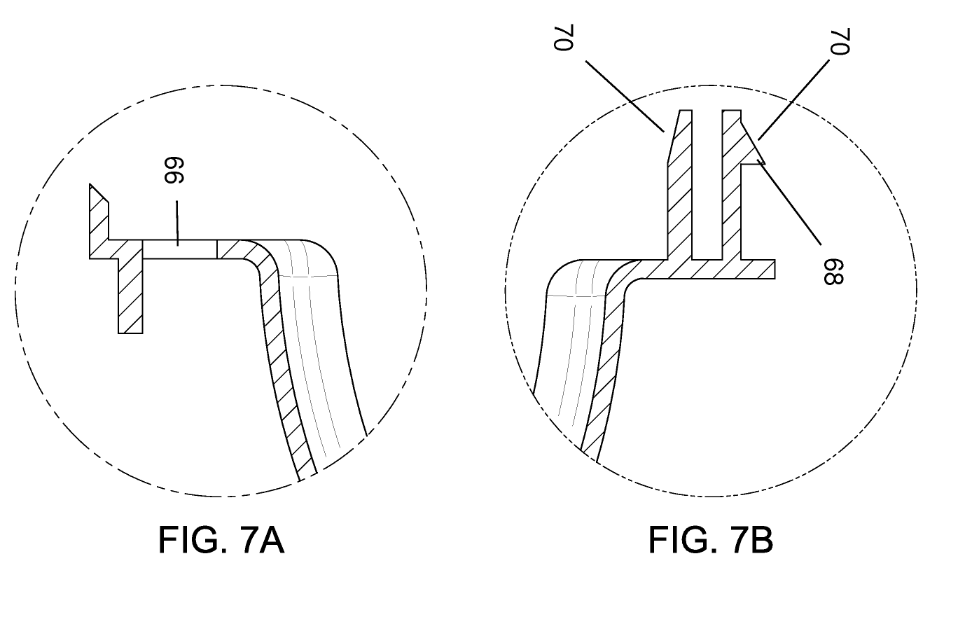

Referring to FIGS. 1 through 7B, the present invention may include a corrugated coupling 10 for coupling two corrugated sections 20. The corrugated coupling 10 may be made of material that can be repeatedly bent without fracturing, such as polyethylene, polypropylene, vinyl, nylon, rubber, various impregnated or laminated fibrous materials, various plasticized materials. The corrugated coupling 10 may include a pair of opposing portions 12A, 12B, which have aligned alternating corrugated sections of ridges 14 and grooves 16. The ridges 14 and grooves 16 may be arranged and spaced for mating with a portion of the complementary ridges 34 and grooves 36 of the corrugated sections 20 being coupled.

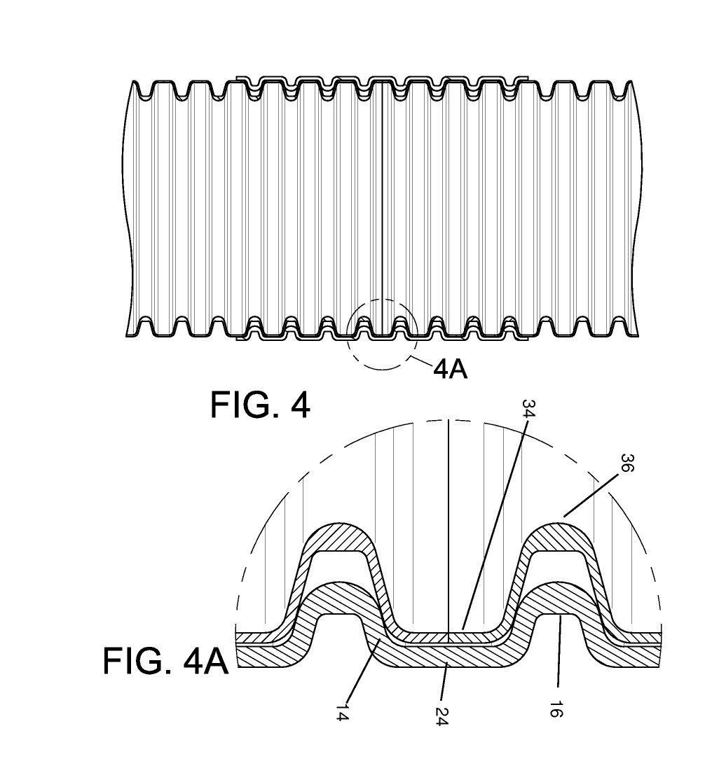

Each opposing portions 12A, 12B may be substantially half of a tubular element that may be the corrugated coupling 10 in a closed configuration. An effective outside diameter of the corrugated coupling 10, when the pair of opposing portions 12A, 12B are in the closed configuration, as defined by the flat segments 24 of the ridges 14 may be uniform along the length of the corrugated coupling 10. The effective outside diameter is adapted to snugly envelope an effective outside diameter of the corrugated sections 20. The flat segments 24 may be rounded and suitable sized for enabling mating with the complementary ridges 34 being coupled, as illustrated in FIGS. 4 and 4A.

The grooves 16 may be suitably shaped for enabling mating with complementary grooves 36 of the corrugated sections 20 being coupled, as illustrated in FIGS. 4 and 4A. The depths of the grooves 16 may be suitably shallower than the complementary grooves 36, forming a gap therebetween for enabling adequate as illustrated in FIGS. 4 and 4A. The gap affords the corrugated coupling 10 to be used to repair damaged sections of pipe that have been buried. In order for the corrugated coupling 10 to seal properly the soil in the complementary grooves 36 may need to be cleaned out if not for the gap, which may not be practical in some in situ situations, if not very difficult. The shallow grooves 16 on the corrugated coupling 10 may be designed so that it will still function properly if the complementary grooves 36 are not fully cleaned out.

The opposing portions 12A, 12B may be pivotably connected to one another along the entirety of first edges 32A and 32B by an integral hinge 40 that pivots along a fold segment 42 disposed between first edges 32A and 32B, so that the coupling 10 is positionable from a closed configuration to an open configuration. The hinge 40 may be integrated to the coupling 10 so as to eliminate gaps along the length thereof, where debris could penetrate. The fold segment 42 may be a portion of the hinge 40 having a decreased cross sectional area so that bending forces about the hinge 40 “buckles” the fold segment 42 portion before other portions of the hinge 40.

The perimeter of the corrugated coupling 10 is formed by outer edges 52A and 52B. Integrated along the length of outer edges 52A and 52B may be a snap closure means 50 for latching opposing portions 12A, 12B together.

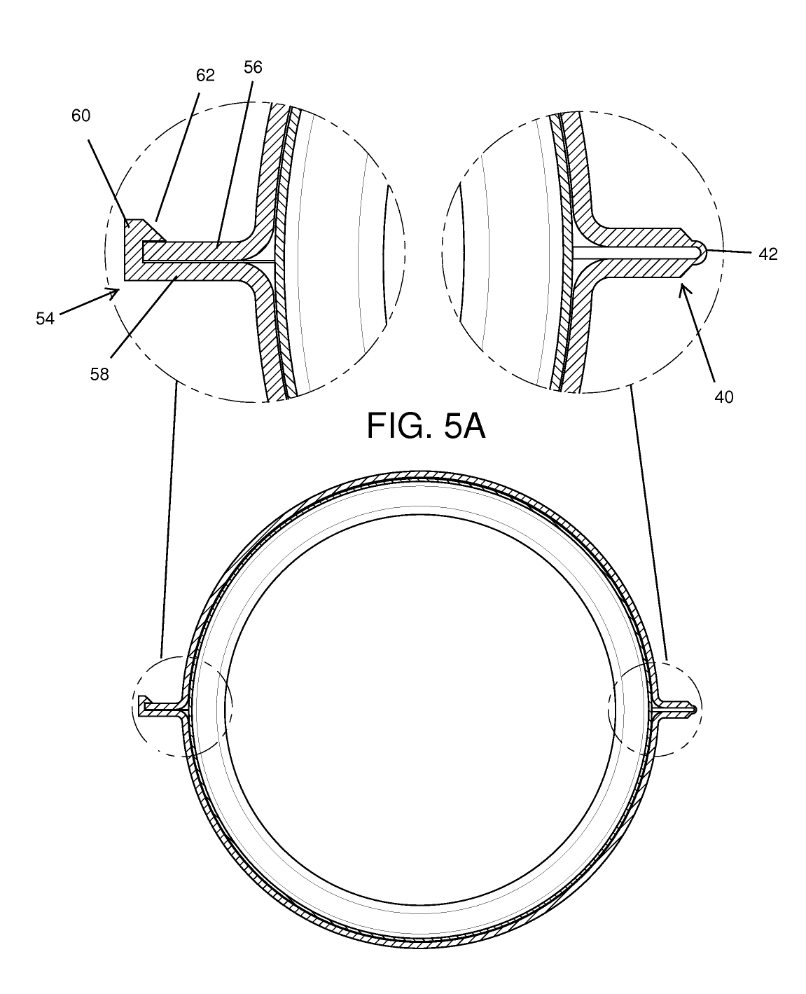

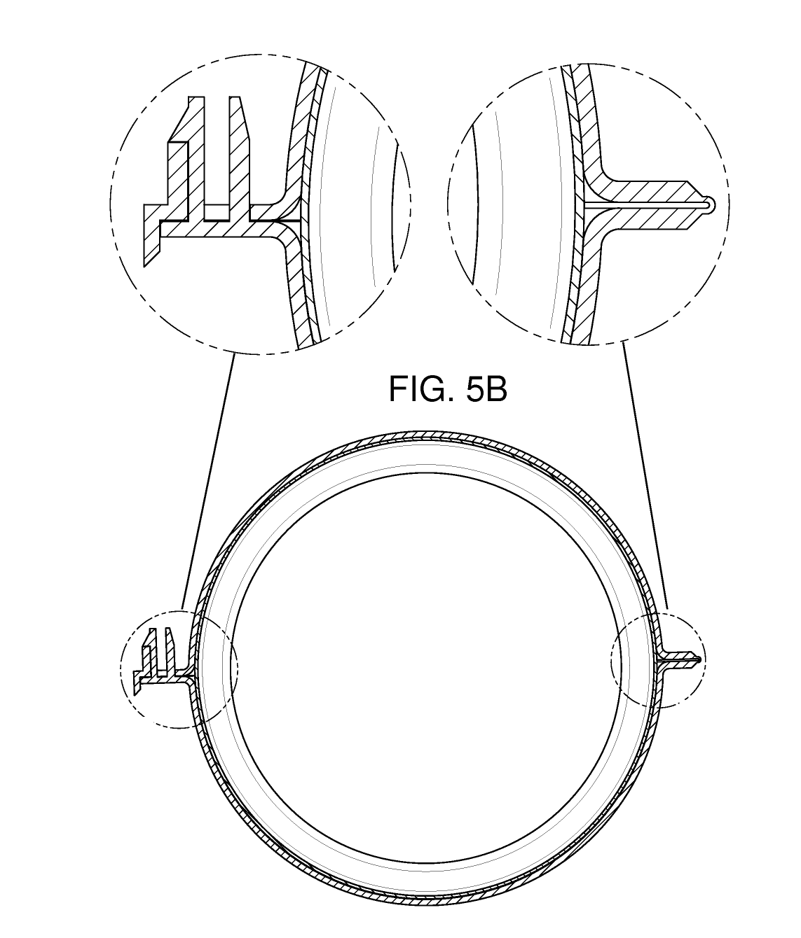

According to the embodiment illustrated in FIG. 5A, the snap closure means 50 includes a latching hook segment 54 and a complementary snap cantilever segment 56 which interact and lock the coupling 10 in the closed configuration when the opposing portions 12A, 12B are brought together. The snap closure 50 may be positionable in a locked position and an unlocked position that complement the closed configuration and the open configuration, respectively. In the locked position the corrugated coupling 10 may be designed to form a tight joint with the corrugated sections 20 or other pipes and tubes they sandwich, preventing the latter from being pulled out from the corrugated coupling 10.

The snap cantilever 56 extends radially outwards from the second outer edge 52B having a generally rectangular cross-section. The latching hook 54 extends radially outwards from the first outer edge 52A and comprises a body portion 58 joined along its length to a latching portion 60. The body portion 58 may have a generally rectangular cross-section substantially similar to the cross-section of the snap cantilever 56. The latch portion 60 may have a L-shape that extends generally perpendicularly from the body portion 58 facing the snap cantilever 56 so as to present a lead-in notch 62 near the distal end of the latch portion 60 for facilitating the interacting of the segments 54, 56 when the coupling moves to the closed configuration.

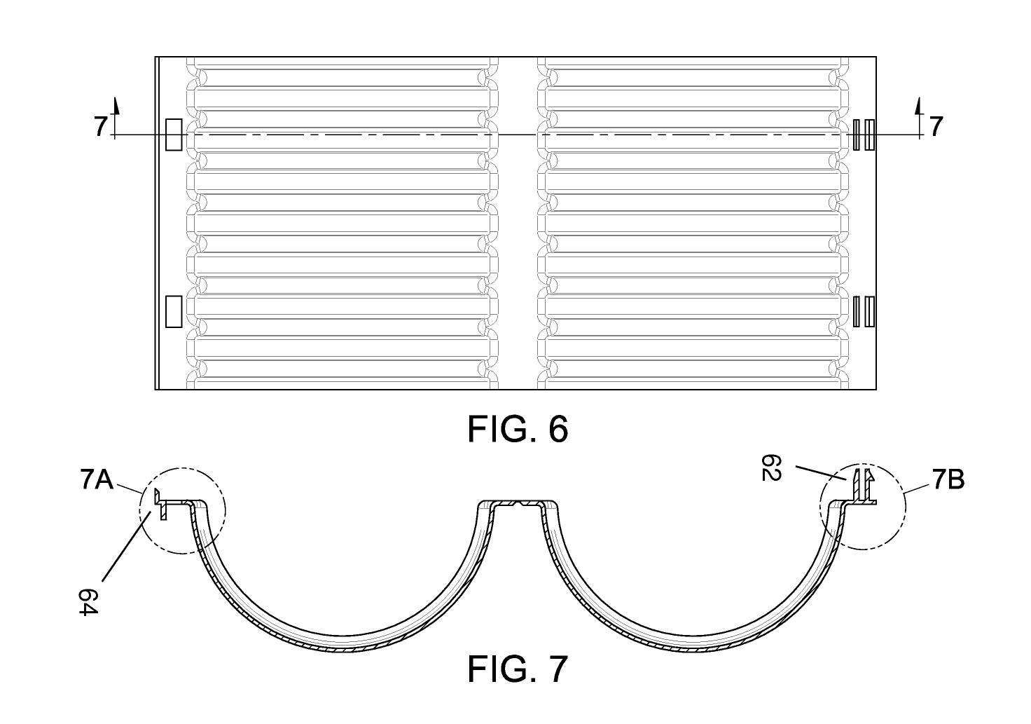

In an alternative embodiment, the snap closure means 50 may include a plurality of F-shaped prongs 62 and a prong snap cantilever 64. The plurality of F-shaped prongs 62 may be arranged spaced apart and perpendicularly joined along portions of the first outer edge 52A. The prong snap cantilever 64 may define prong apertures 66 cooperating with the F-shaped prongs 62 for receiving and latching thereto. The prong snap cantilever 64 may be perpendicularly joined along the length of second outer edge 52B, as illustrated in FIG. 6. Each F-shaped prong may have at least one lead-in beveled edge 70 and a latching flange 68 for facilitating reception by the prong apertures 66 and for latching to the prong apertures 66, respectively. The prong snap cantilever may be integrated along the length of second outer edge 52B.

The integrated components 40, 54, 56 are formed simultaneously when manufactured as a unitary piece. The sheet may be formed in any suitable way of unitary construction, including but not limited to injection molding, casting, stamping, extrusion, milling, 3D printing or the like.

A method of using the present invention may include the following. Providing the corrugated coupling 10 as disclosed above. In the open configuration, a user may place the two corrugated sections 20 end to end within one half of the pair of opposing portions 12A, 12B so that at least a predetermined number of complementary ridges 34 mate with the ridges 14 of the one coupling 10 half. In certain embodiments, the predetermined number of complementary ridges 34 is three. Then the user moves the coupling 10 to the closed position resulting in the interacting and locking of the snap closure. Upon completion of use, the user may unlock the snap closure 50, move the pair of opposing portions 12A, 12B to the open position, and remove at least one of the two corrugated sections 20.

In certain embodiments, the corrugated coupling 10 may be used to easily repair pipe or tube sections that have been damaged, preventing roots and debris from penetrating the pipe in the damaged area.

It should be understood, of course, that the foregoing relates to exemplary embodiments of the invention and that modifications may be made without departing from the spirit and scope of the invention as set forth in the following claims.

What is claimed is:

1. A corrugated tubular coupling for tightly sandwiching at least one cylindrical corrugated section, comprising:
a first portion of the tubular coupling, wherein the first portion is defined along its length by a first edge and a first outer edge,
a second portion of the tubular coupling, wherein the second portion is defined along its length by the first edge and a second outer edge, wherein the first and second portions are pivotably connected along the first edge; and
a snap closure provided along the length of the outer edges, the snap closure positionable in a locked position sandwiching the at least one cylindrical corrugated section between the first portion and the second portion and an unlocked position.

2. The corrugated tubular coupling of claim 1, wherein the first edge is an integrated hinge.

3. The corrugated tubular coupling of claim 2, wherein the integrated hinge provides a fold segment.

4. The corrugated tubular coupling of claim 1, wherein the snap closure is integrated along the length of the outer edges.

5. The corrugated tubular coupling of claim 4, wherein the snap closure further comprises:
a latching hook perpendicularly joined to the first outer edge; and
a snap cantilever perpendicularly joined to the second outer edge.

6. The corrugated tubular coupling of claim 5, wherein the latching hook further forms a L-shape, wherein the L-shape has a latch portion facing the snap cantilever so as to present a lead-in notch near a distal end of the latch portion for facilitating the locked position.

7. The corrugated tubular coupling of claim 4, wherein the snap closure the further comprises:
a plurality of F-shaped prongs arranged spaced apart and perpendicularly joined to the first outer edge; and
a snap cantilever defining prong apertures for latching to the F-shaped prongs, wherein the snap cantilever is perpendicularly joined to the second outer edge.

8. The corrugated tubular coupling of claim 4, wherein the F-shaped prongs further provide lead-in beveled edges and a latching flange.

9. A method of sandwiching at least one cylindrical section having a plurality of corrugated segments, comprising the steps of:
providing a tubular coupling having a plurality of corrugated segments, wherein the tubular coupling comprises: a first portion of the tubular coupling, wherein the first portion is defined along its length by a first edge and a first outer edge, a second portion of the tubular coupling, wherein the second portion is defined along its length by the first edge and a second outer edge, wherein the first and second portions are pivotably connected along the first edge; a snap closure provided along the length of the outer edges, and the snap closure positionable in a locked position sandwiching the at least one cylindrical corrugated section between the first portion and the second portion and an unlocked position;
placing the at least one cylindrical corrugated section on the first or second portion so that the each cylindrical corrugated section has at least a predetermined number of corrugated segments mated with the complementary corrugated segments of the first or second portion; and
positioning the snap closure in the locked position.

10. The method of claim 9, wherein the at least one cylindrical corrugated section is two cylindrical corrugated sections laid end-to-end so as to form a secure joint therebetween.
